(19) United States
(12) Patent Application Publication
(10) Pub. No.: US 2011/0119930 A1
(43) Pub. Date: May 26, 2011

(54) Electric Hair Cutting Machine

(75) Inventor: Peter Scheunert, Kuenzell (DE)

(73) Assignee: The Procter & Gamble Company, Cincinnati, OH (US)

(21) Appl. No.: 12/950,204

(22) Filed: Nov. 19, 2010

Related U.S. Application Data
(63) Continuation of application No. PCT/US2009/044470, filed on May 19, 2009.

(30) Foreign Application Priority Data
May 20, 2008 (EP) 08156531.9

(51) Int. Cl. B26B 15/00

(52) U.S. Cl. 30/228

(57) ABSTRACT

An electric hair cutting machine is disclosed.

In order to achieve optimized handling and a smooth-running mechanical system, which enables a minimized drive, it is proposed that the cutting plane form an angle of from 10 to 70 degrees, or preferably of from 20 to 30 degrees, with the longitudinal axis of the gripping piece, and that the sliding block be designed in the form of a cylinder that extends in the direction indicated or in the form of a ball.

### CROSS REFERENCE TO RELATED APPLICATION

This application is a continuation application of prior copending International Application No. PCT/US2009/044470, filed May 19, 2009, designating the U.S.

The subject matter of the invention relates to the salon industry and an electric hair cutting machine therein.

### FIELD OF INVENTION

Electric hair cutting machines are sufficiently well-known. They are used to cut scalp hair and are an alternative to cutting hair using scissors.

U.S. Pat. No. 5,959,878 discloses a cutting machine for lawn-mowing whose drive technology could be used in a hairdressing salon if it were adapted to the requirements in the salon industry with respect to its dimensions and cutting accuracy. This electric cutting machine is equipped with a gripping piece, which has a longitudinal axis, as well as a drive, a fixed clipper blade, a clipper blade that is aligned parallel to and adjoins the fixed clipper blade and can be moved back and forth on a cutting plane, as well as gearing, which transfers a rotational movement of a drive shaft to the movable clipper blade. The drive shaft has a reversing device that has an eccentric in order to convert the rotational movement into a linear back-and-forth movement. A reversing lever, which can be swiveled around a bearing axle, connects the reversing device to the movable clipper blade. A disk, in the form of a sliding block, is attached to a pin on the eccentric, wherein the sliding block is held in position by a retainer on the end of the reversing lever, and the retainer is designed, in a direction that is vertical with respect to the drive shaft, such that the sliding block executes an up-and-down movement in this direction.

DE 103 38 401 A1 discloses a hair cutting machine from the hair salon industry, wherein the cutting plane forms an angle between 10 and 70 degrees with the longitudinal axis of the gripping piece. This angle enables easy handling and function.

### BACKGROUND OF THE INVENTION

The known prior art has the disadvantage that there is no particularly location-specific and smooth-operating reversing device for an electric hair cutting machine that is also easy to handle. Thus, the subject matter of U.S. Pat. No. 5,958,878 requires a relatively high amount of drive capacity and the subject matter of DE 103 38 401 A1 has a relatively imprecisely functioning reversing device.

The object was to further develop the subject matter of the preamble of Claim 1 in a manner such that the disadvantage mentioned is eliminated.

### SUMMARY OF THE INVENTION

The object is achieved in that the cutting plane forms an angle of from 10 to 70 degrees with the longitudinal axis of the gripping piece and that the sliding block is constructed in the form of a cylinder that extends in a direction that is vertical with respect to the drive shaft or is constructed in the form of a ball.

The proposed hair cutting machine has the advantage that it has an advantageous angle, because said angle is between 10 and 70 degrees. It is preferable if said angle is between 20 and 30 degrees, with between 20 and 25 degrees being particularly preferred, such that this angle enables a haircut that essentially corresponds to hair that is cut with scissors and that this is accomplished with ergonomically advantageous handling and function that is suitable for the application. The drive capacity, meaning the size of the drive, and optionally the usage time of a battery are minimized, because the reversing device transfers the forces to be transferred precisely and beneficially and thus the forces are transferred in a manner that is low-wearing. Thus, the design of the sliding block as a cylinder or as a ball is suitable for ensuring a secure and low-wearing transfer of force. The sliding block can have a drill hole, in a well-known design, in which the pin is inserted, and whereby the sliding block is connected to the pin in a rotating manner.

If the sliding block is designed as a cylinder having at least one flat spot (A2), this results in multiple advantages. On one hand, a recess provided in the external surface of the cylinder, which is wearing along the entire length of the cylinder, serves to define a location-specific reference, which can be used to calculate relative movements. On the other hand, non-flattened surface areas of the cylinder are used for location-specific transfer of force. A flat spot that is transverse with respect to the center axis of the pin (A3) has the advantage that it does not change any surface area of the cylinder that is important for the transfer of movement. The same thing applies to a flat spot that is parallel with respect to the center axis of the pin (A4). A particularly precise production of the sliding block is possible and the transfer of force is optimized when there is a flat spot that is transverse with respect to the center axis as well as a flat spot that is parallel with respect to the center axis (A5). The flat spots are taken into consideration when the sliding block is held in an end of the reversing lever, and they do not interfere with the swivel movement of the reversing lever if, according to A6, the sliding block is held in the retainer via positive engagement on the curved surface of the sliding block, and the sliding block can be slid along the pin.

In principle, the sliding block can be held stationary in the retainer and can be slid along the pin. Alternatively, the technical embodiment can also be designed such that the sliding block is movable in the retainer in the direction of the extension of the reversing lever and that the sliding block is mounted on the pin (12) in a manner that is stationary.

This embodiment is suitable for both a sliding block in the form of a ball as well as a sliding block in the form of a cylinder. In this embodiment, no flat spot is provided parallel to a wall of the retainer if, according to A8, the retainer has two walls that are parallel with respect to one another that extend in the direction of the reversing lever and that adjoin the sliding block on opposing sides with play between the sliding block and the walls. The play is at its maximum when the reversing lever is in the center, i.e. when it is aligned straight out. Furthermore, if the play is zero when the reversing lever is swiveled to the maximum on the left and the right, this results in the maximally precise transfer of the drive to the movable clipper blade.

The proposed hair cutting machine is described in more detail in the following using figures showing two exemplary embodiments. The following is shown:

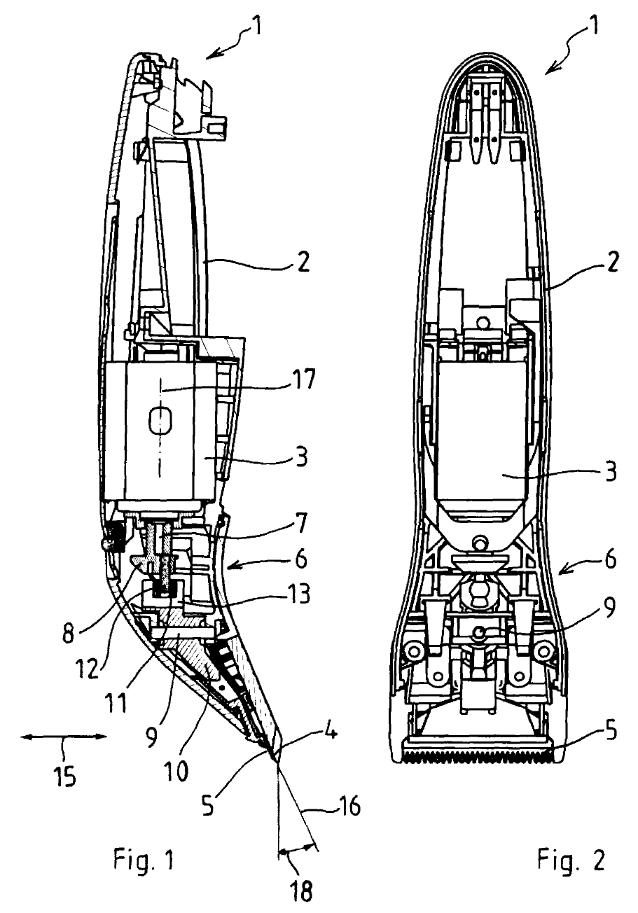

FIG. 1 shows a vertical section of a hair cutting machine with a sharp angle between both of its clipper blades as well as a longitudinal axis of a gripping piece;

FIG. 2 shows a horizontal section of the subject matter of FIG. 1;

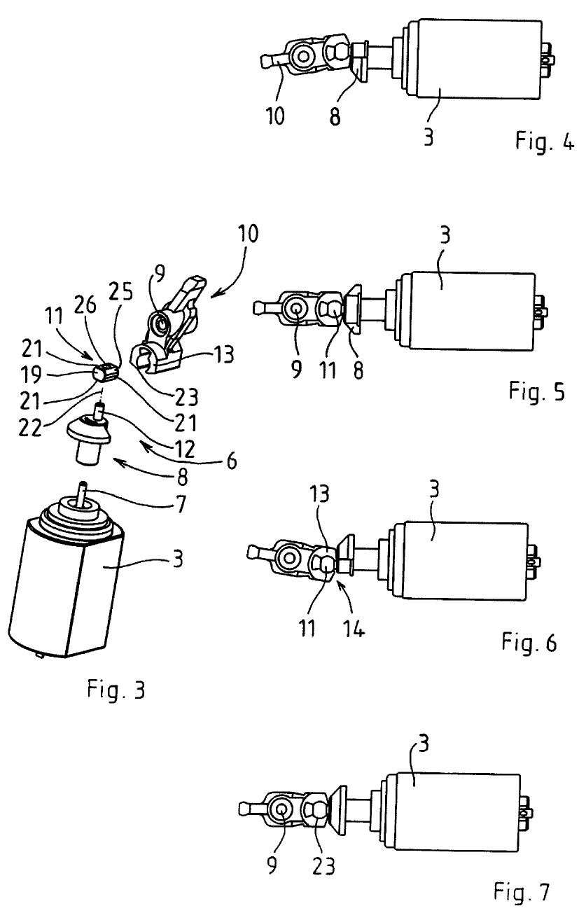

FIG. 3 shows a perspective representation with components that are separated from one another, a drive, an eccentric that can be placed on a drive shaft, a cylindrical sliding block, with flat spots, that can be attached to a pin of the eccentric, and a reversing lever with a retainer to hold the sliding block;

FIG. 4 is a view from above showing the subject matter of FIG. 3, but in an assembled state in a first rotational condition of the eccentric;

FIG. 5 is a view from above of the subject matter of FIG. 4, but with the eccentric rotated an additional 90 degrees;

FIG. 6 is a view from above of the subject matter of FIG. 5, but with the eccentric rotated an additional 90 degrees;

FIG. 7 is a view from above of the subject matter of FIG. 6, but with the eccentric rotated an additional 90 degrees;

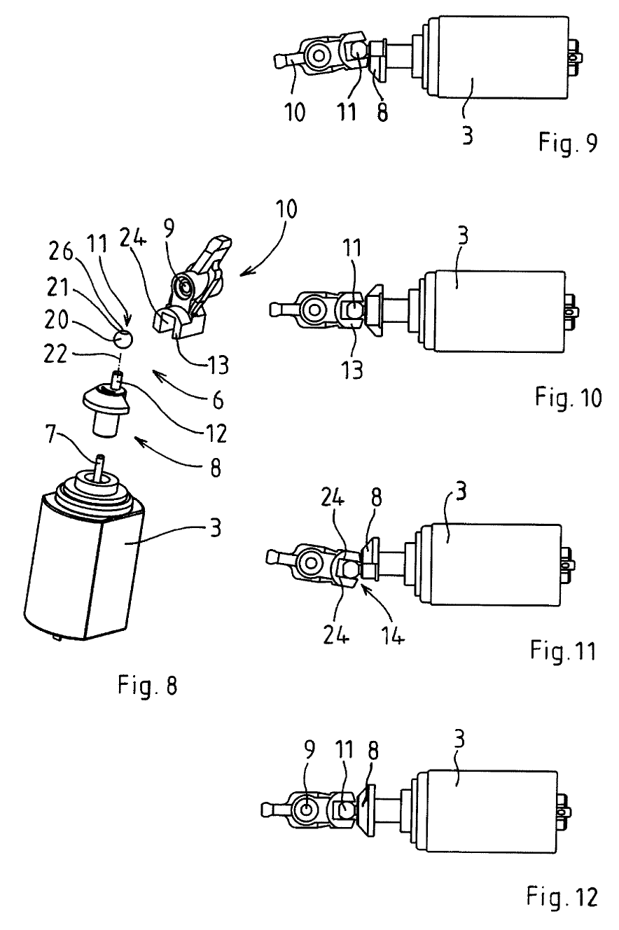

FIG. 8 shows a perspective representation with components that are separated from one another, a drive, an eccentric that can be placed on a drive shaft, a spherical sliding block, with flat spots, that can be attached to a pin of the eccentric, and a reversing lever with a retainer to hold the sliding block;

FIG. 9 is a view from above showing the subject matter of FIG. 8, but in an assembled state in a first rotational condition of the eccentric;

FIG. 10 is a view from above of the subject matter of FIG. 9, but with the eccentric rotated an additional 90 degrees;

FIG. 11 is a view from above of the subject matter of FIG. 10, but with the eccentric rotated an additional 90 degrees; and

FIG. 12 is a view from above of the subject matter of FIG. 11, but with the eccentric rotated an additional 90 degrees.

### DETAILED DESCRIPTION OF THE INVENTION

With an electric hair cutting machine 1 having a gripping piece 2, a longitudinal axis 17 of the gripping piece 2, a drive 3, a fixed clipper blade 4, a clipper blade 5 that is aligned parallel to the fixed clipper blade 4 and that adjoins it in a cutting plane 16 and that can be moved back and forth, gearing 6 transfers a rotational movement of a drive shaft 7 to the movable clipper blade 5 (FIGS. 1 and 2). The drive shaft 7 has an eccentric 8 as a reversing device (FIG. 3) in order to convert the rotational movement into a linear back-and-forth movement (FIGS. 4 through 7). A reversing lever 10, which can be swiveled around a bearing axle 9, connects the reversing device to the movable clipper blade 5. A sliding block 11 is provided on a pin 12 of the eccentric 8, wherein the sliding block 11 is held in position by a retainer 13 on one end 14 of the reversing lever 10. The retainer 13 is designed in a direction 15 that is vertical with respect to the drive shaft 7 such that the sliding block 11 executes an up-and-down movement in this direction 15. The cutting plane 16 forms an angle 18 of 23 degrees with the longitudinal axis 17 of the gripping piece 2. The sliding block 11 is designed in the form of a cylinder 19 that extends vertically upwards in the indicated direction 15. The gripping piece 2 is designed to hold a battery, wherein the hair cutting machine 1 is designed to charge the battery at a charging station.

The sliding block 11 has two flat spots 21 that are transverse with respect to the center axis 22 of the pin 12, on opposing sides of the sliding block 11 (FIG. 3). In addition, a flat spot 21 is provided which is parallel with respect to the center axis 22. As an alternative to this, a flat spot 21 that is parallel with respect to the center axis 22 could be designed on each of the two opposing sides of the sliding block 11. The sliding block of 11 is held in the retainer 13 via positive engagement 23 on the curved surface 25. The sliding block 11 has a drill hole 26 in which the pin 12 is inserted so that the sliding block 11 can be slid along the pin 12.

With the exemplary embodiment according to FIGS. 8 through 12, the sliding block 11 is designed in the form of a ball 20. Said ball 20 can be moved in the retainer 13 in the direction of the extension of the reversing lever, because the sliding block 11 is mounted on the pin 12 in a stationary manner. The retainer 13 has two walls 24, which are parallel with respect to one another and which extend in the direction of the reversing lever 10, and which adjoin the sliding block 11 on opposing sides with play between the sliding block 11 and the walls 24.

As an alternative to both of the examples, the cylindrical sliding block 11 of the first example could also be attached to the pin 12 in a stationary manner and be held in a retainer 13 with parallel walls, and the spherical sliding block 11 of the second example could be held in a sliding manner on the pin 12 and limited by the retainer 13 via positive engagement.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An electric hair cutting machine (1) having a gripping piece (2), a longitudinal axis (17) of the gripping piece (2), a drive (3), a fixed clipper blade (4), a clipper blade (5) that is aligned parallel to the fixed clipper blade (4) and that adjoins it in a cutting plane (16) and that can be moved back and forth, as well as gearing (6) that transfers a rotational movement of a drive shaft (7) to the movable clipper blade (5), wherein the drive shaft (7) has a reversing device, preferably an eccentric (8), in order to convert the rotational movement into a linear back-and-forth movement, with a reversing lever (10), which can be swiveled around a bearing axle (9), wherein the reversing lever (10) connects the reversing device to the movable clipper blade (5), as well as with a sliding block (11) on a pin (12) of the eccentric (8), wherein the sliding block (11) is held in position by a retainer (13) on one end (14) of the reversing lever (10), and the retainer (13) is designed in a direction (15) that is vertical with respect to the drive shaft (7) such that the sliding block (11) executes an up-and-down movement in this direction (15), characterized in that the cutting plane (16) forms an angle (18) of from 10 to 70 degrees, or preferably of from 20 to 30 degrees, with the longitudinal axis (17) of the gripping piece (2), and that the sliding block (11) is designed in the form of a cylinder (19) that extends in the direction (15) indicated or is designed in the form of a ball (20).

2. The hair cutting machine according to claim 1, wherein the sliding block (11) is designed as a cylinder (19) having at least one flat spot (21).

3. The hair cutting machine according to claim 2, wherein the a flat spot (21) is provided that is transverse with respect to the center axis (22) of the pin (12).

4. The hair cutting machine according to claim 2, wherein the a flat spot (21) is provided that is parallel with respect to the center axis (22) of the pin (12).

5. The hair cutting machine according to claim 2, wherein the a flat spot (21) that is transverse with respect to the center axis (22) as well as a flat spot (21) that is parallel with respect to the center axis (22) is provided.

6. The hair cutting machine according to claim 1, wherein the sliding block (11) is held in the retainer (13) via positive engagement (23) on a curved surface (25) and that the sliding block (11) can be slid along the pin (12).

7. The hair cutting machine according to claim 1, wherein the sliding block (11) can be moved in the retainer (13) in the direction of the extension of the reversing lever (10) and that the sliding block (11) is mounted in a fixed position on the pin (12).

8. The hair cutting machine according to claim 7, wherein the retainer (13) has two walls (24), which are parallel with respect to one another and which extend in the direction of the reversing lever (10), and which adjoin the sliding block (11) on opposing sides with play between the sliding block (11) and the walls (24).
